(19) United States
(12) Patent Application Publication
(10) Pub. No.: US 2004/0090092 A1
(43) Pub. Date: May 13, 2004

(54) Motor vehicle with an alterable rear structure

(75) Inventors: Francois de Gaillard, Mouilleron en Pareds (FR); Martin de Waal, Assendelft (NL); Jean-Luc Guicheteau, Cholet (FR); Izumi Kimoto, Hiroshima (JP); Michael Koelbl, Neuried (DE); Alain Leroy, Dissen-Dettenschwang (DE); Martin Pollak, Puchheim (DE); Claudio Ivano Righetti, Torino (IT); Thomas Rudolph, Hechendorf (DE); Sigeru Ueki, Higashihiroshima-City (JP); Bernhard Vecchioni, Oxford, MI (US)

Correspondence Address: NIXON PEABODY, LLP, 401 9TH STREET, NW, SUITE 900, WASINGTON, DC, 20004-2128, US

(73) Assignee: Webasto Vehicle Systems International GmbH, Stockdorf (DE)

(21) Appl. No.: 10/622,114

(22) Filed: Jul. 18, 2003

(30) Foreign Application Priority Data
Jul. 20, 2002 (DE) 102 33 029.8

(51) Int. Cl. B60J 7/053

(52) U.S. Cl. 296/222

(57) ABSTRACT

A motor vehicle, especially a passenger car (1), with an alterable rear structure (2), the rear structure (2) comprising at least one roof element (3), two opposing side elements (12, 13) and one rear element (4), the roof element (3) being located in the open position of the rear structure (2) in the rear floor area (21) of the motor vehicle. In the open position, the rear area of the vehicle has an open-bed, pickup truck configuration.

### BACKGROUND OF THE INVENTION

1. Field of the Invention

The invention relates to a motor vehicle with an alterable rear structure which comprises at least one roof element, two opposing side elements and one rear element, especially a passenger vehicle, with an alterable rear structure, the rear structure comprising at least one roof element, two opposing side elements and a rear element.

2. Description of Related Art

By means of an alterable rear structure a motor vehicle, especially a passenger vehicle, such as a station wagon or all-terrain vehicle with a closed rear, can be converted into a vehicle with an open cargo area, for example, into a pick-up truck. Published German Patent Application DE 196 16 118 A1 discloses a motor vehicle in which, among others, the rear roof part and the rear roof and body columns can be removed. The columns are transferred into an idle position which is essentially not visible on the motor vehicle by pushing or pivoting. The removable rear roof part can be deposited, for example, in a side door. Such a rear structure requires that at least one individual be available for transport and stowage of the rear roof part in the side door.

Published German Patent Application DE 100 28 777 A1 relates to a motor vehicle with an alterable rear structure which is comprised of a rear roof element and a module which has D columns which are located on each side. In the open position of the rear structure, the roof element is located over the front motor vehicle roof, causing the motor vehicle to experience increased wind resistance. Furthermore, opening of the remainder of the motor vehicle roof is not possible as a result of the roof element which is located near the front area of the motor vehicle roof in the open position of the rear structure.

U.S. Pat. No. 6,517,135 of one of the present inventors and commonly owned with the present application discloses a motor vehicle with a convertible passenger compartment. In one disclosed embodiment, a vehicle is convertible from a station wagon configuration into a pick-up truck configuration by telescoping of the rear body portion forward to under the roof of the passenger compartment after removal of the windows.

### SUMMARY OF THE INVENTION

Accordingly, it is a primary object of this invention to provide a motor vehicle with an alterable rear structure which enables conversion of the rear structure easily and quickly without significantly increasing the wind resistance of the motor vehicle and with an open motor vehicle roof area that is as large as possible.

This object is achieved according to the invention by the roof element being located in the rear floor area of the motor vehicle when the rear structure is in the open position.

One important aspect of the invention is that, in a motor vehicle, especially a passenger car with an alterable rear structure which comprises at least one roof element, two opposing side elements and a rear element, when the rear structure is in the open position, the roof element is located in the rear floor area of the motor vehicle. Such an arrangement of the roof element is accomplished by means of guide rails which are connected to the C and D columns of the motor vehicle, in which the rear roof element and other roof elements which are located toward the front of the motor vehicle, stacked on top of one another, can be lowered into the rear floor area of the motor vehicle. In this way, at least one roof element can be quickly and easily stowed without increased wind flow resistances forming in addition in this way.

According to a preferred embodiment, the roof element in the open position of the rear structure can be covered by a folding floor cover so that with the roof element lowered a closed floor area, for example, of a pick-up truck, can be formed. In this way, no additional obstacles are formed by projecting edges and corners of the lowered roof element during loading and unloading of cargo onto and off of the cargo surface of the pick-up.

In addition to the lowerable roof element, the side elements and at least parts of the D columns can be moved out of the closed position into the open position toward the front of the vehicle along its side. In addition, the rear element can be lowered in the body, especially in a tail gate. If the rear element, the side elements and the roof element are lowered or pushed in the direction of the front of the vehicle, there is the open position of the rear structure such that it is a pick-up with an open cargo area. Such a pick-up can be used to transport cargos which could not be carried in a vehicle with a closed rear due to their dimensions.

If the rear structure is in the closed position, the passenger car has a closed vehicle rear, by which a station wagon is formed.

According to a preferred embodiment of the invention, between the open cargo space which is produced by the open position of the rear structure and the passenger compartment in the front vehicle area, there is a cargo space separation, especially a separating window. This cargo space separation is preferably pushed behind the rear seat backs between a lowered position and a raised separating position against the motor vehicle roof. Such displacement of the cargo space separation is preferably accomplished by guide rails which are connected to the rear seat backs and which, like the cargo space separation, can be folded with the rear seat backs.

According to one development of the invention, there is a seat unit in the open position of the rear structure with the seat surface folded up with a capacity to move towards the front of the vehicle. In this way, with the rear structure open, an additional row of seats can be used. This row of seats with the rear structure opened can be pushed forward quickly and easily by means of floor-side guide rails which are provided for this purpose so that a pick-up cargo area as large as possible is attained.

Preferably, to move the elements there are drive means which can be controlled via the actuation means. The actuation means is used to set the opening process for opening the rear structure in which the elements including the parts of the D columns can be moved out of a closed or partially open position into the open position. Accordingly, it is no longer necessary for an individual to get out to open or close the rear structure, assuming that the actuating means is located for example in the dashboard of the motor vehicle.

The rear element of one or more of the roof elements and/or the side elements can be made of a transparent material in order to achieve a rear area as bright as possible on the inside of the vehicle with the rear structure closed.

Advantages and expediencies can be taken from the following description in conjunction with the drawings.

### BRIEF DESCRIPTION OF THE DRAWINGS

FIG. 1A is a schematic side view of a motor vehicle with a rear structure according to one embodiment of the invention in the closed position;

FIG. 1B is a schematic top view of the motor vehicle according to the embodiment of the invention shown in FIG. 1A with the rear structure in the closed position;

FIG. 1C is a schematic perspective view of the motor vehicle according to the embodiment of the invention shown in FIGS. 1A & 1B with the rear structure in the open position;

FIG. 1D is a schematic rear view of the motor vehicle according to the embodiment of the invention shown in FIGS. 1A-1C with the rear structure in the open position;

FIG. 2A is a schematic perspective view of a motor vehicle according to another embodiment of the invention with the rear structure in the closed position;

FIG. 2B is a schematic perspective view of the motor vehicle according to the embodiment of the invention shown in FIG. 2A with the rear roof section being lowered;

FIG. 2C is a schematic perspective view of the motor vehicle according to the embodiment of the invention shown in FIGS. 2A & 2B with the rear structure in a partially open position;

FIG. 2D is a schematic perspective view of the motor vehicle according to the embodiment of the invention shown in FIGS. 2A-2C with the rear structure in the open position, and

FIG. 2E is a schematic side view of the motor vehicle according to the embodiment of the invention shown in FIGS. 2A-2D with the rear structure in the open position.

### DETAILED DESCRIPTION OF THE INVENTION

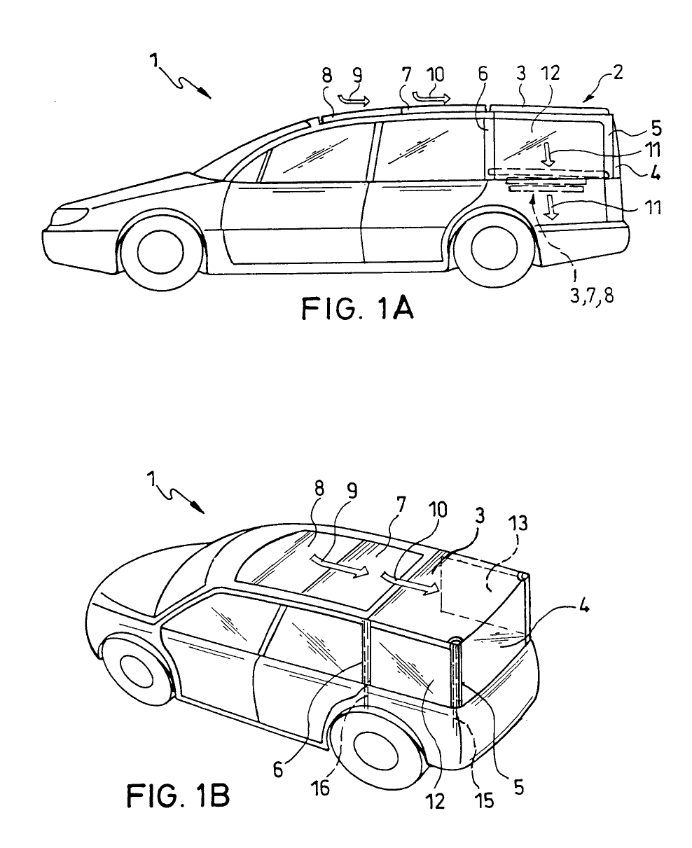

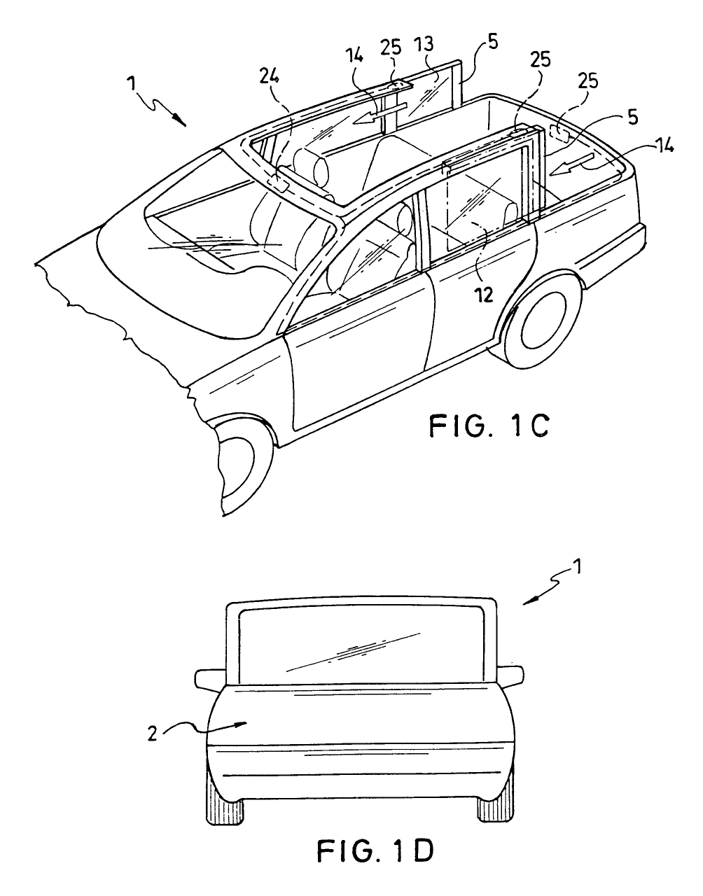

The motor vehicle 1 which is shown in FIGS. 1A-1D, according to the first embodiment of the invention, has a rear structure 2 which, among others parts, comprises a roof element 3, a rear element 4, D columns 5 and C columns 6. In order to move the rear structure 2 from the closed position shown here into the open position, optionally roof elements 7, 8 which are located towards the front of the vehicle (as represented by arrows 9, 10), are opened in the manner of a sliding roof and are pushed to the rear in order to then be located with the rear roof element 3, on top of one another in the rear area of the motor vehicle. This stacking of roof elements 3, 7, 8 on top of one another can be achieved by means of guide rails which are connected to the C and D columns in the rear area. Then, the stack is lowered, as is indicated by the arrows 11. To facilitate lowering of the rear roof element 3, as shown in FIG. 1B, its rear corners are notched in correspondence with the D columns.

The rear structure furthermore comprises side elements 12, 13, as are shown in FIGS. 1A, 1B and 1C. These side elements are advantageously made as side windows. The side windows can be pushed along the vehicle sides towards its front as is indicated by the arrow 14 in FIG. 1C. In this way, the rear structure can be quickly moved from its closed into the open position. A motor drive 25 for producing the describe motion of the roof elements 3, 7, 8, side elements 12, 13, and D columns 5 and the actuating means 24 for the drive are schematically represented in FIG. 1C.

FIG. 1D shows a schematic rear view of the motor vehicle according to the first embodiment of the invention with a rear structure in the open position. The open position of the rear structure enables conversion of a station wagon into a pick-up in which both the side elements and also the rear element and the roof element including the D columns have been pushed in order to obtain an open cargo area.

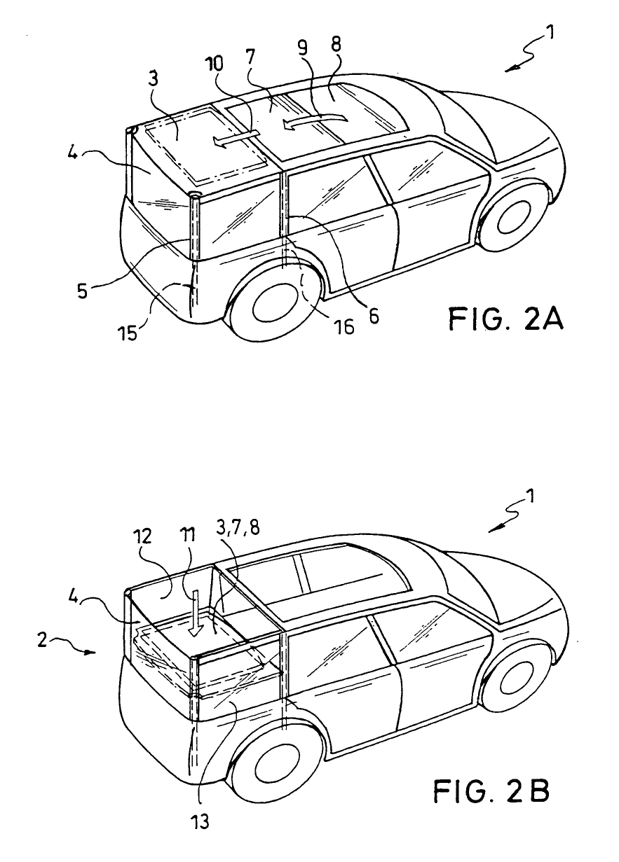

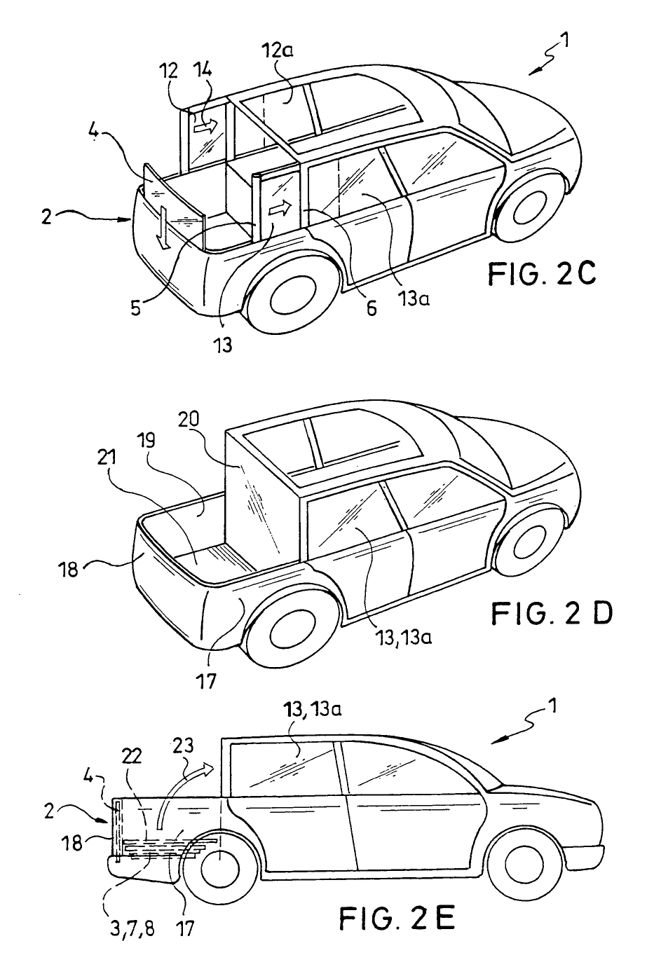

The second embodiment of a motor vehicle in accordance with the invention is shown in FIG. 2A with a rear structure in the closed position. FIG. 2A, in conjunction with the representation in FIG. 2B, shows the pushing and lowering of the individual roof elements 3, 7, 8 in order to obtain a passenger car with a completely opened motor vehicle roof.

As indicated by the arrows 9, 10, the roof elements 7, 8 in the front area of the vehicle are pushed to the rear by means of laterally mounted guide rails, and together with the roof element 3 which is located in the rear area, are lowered as a stack of roof elements into the floor area of the rear area of the vehicle. For this purpose, the D columns 5 and C columns 6 have guide rails 15, 16 which are either connected to the columns or are located integrally in them. The roof elements are lowered by electrical control into the floor area of the rear area of the motor vehicle by means of these guide rails 15, 16 on their four corner points.

As soon as the roof elements 3, 7, 8 are in their open position, the side elements 12 and 13 which are made as side windows, together with parts of the D columns, are moved in the guide rails toward the front of the vehicle. The end position of the displaced rear side elements 12, 13 is chosen such that the edges of the side windows 12, 13 terminate essentially with the edges of the side windows 12a, 13a which are located in the rear seat area of the fixed passenger compartment of the motor vehicle.

In addition, the rear element which is shown in FIG. 2C and which is made preferably as a rear window is lowered into a rear hatch 18 which is located under it, as is shown in FIG. 2D.

The schematic perspective view of the motor vehicle shown in FIG. 2D according to the second embodiment of the invention shows the rear structure in the open position. In this position, the rear of the motor vehicle 1 has a cargo area which is bordered essentially by side body parts 17 19 and the rear tail gate 18. Between the cargo area of the pick-up and the fixed passenger compartment, there is a separating window 20 which is located in the area of the rear seat back of the second row of seats with a capacity to be extended.

The floor area 21 of the cargo area comprises, essentially, a foldable floor cover 22, as is shown in FIG. 2E. In the transition of the rear structure from its closed into its open position, the closed floor cover 22 is folded open, as is indicated by the arrow 23. Furthermore, the roof elements 3, 7, 8 are lowered by means of the guide rails 15, 16 into the floor area 21 and then the floor cover 2 is unfolded back into its closed position.

It is pointed out here that all the above described parts, viewed alone for themselves and in any combination, especially the details shown in the drawings, are important to the invention, but modifications thereof will be apparent to one skilled in the art and are intended to be encompassed hereby.

What is claimed is:

1. Motor vehicle with a passenger compartment and an alterable rear structure, the rear structure comprising:
a roof comprising at least one roof element which is movably mounted,
two opposing side elements, and
one rear element,
wherein the at least one roof element is movable into an open position in which the at least one roof element is located in a rear floor area of the motor vehicle.

2. Motor vehicle as claimed in claim 1, wherein the at least one roof element comprises are rear roof element which has a closed position covering the rear structure and a closed vehicle rear is formed and is movable into the open position by means of guide rails.

3. Motor vehicle as claimed in claim 2, wherein the guide rails are connected to C and D columns of the vehicle.

4. Motor vehicle as claimed in claim 1, wherein the at least one roof element is covered in the open position by means of a foldable floor cover in the rear floor area of the vehicle.

5. Motor vehicle as claimed in claim 3, wherein the side elements and at least parts of the D columns are movable towards the passenger compartment of the vehicle along its sides out of the closed into a position in which the rear area of the vehicle is in an open-bed pickup truck configuration.

6. Motor vehicle as claimed in claim 5, wherein the side elements comprise side windows which are located essentially parallel to other side windows in said open-bed pickup truck configuration.

7. Motor vehicle as claimed in claim 6, wherein the rear element is lowerable into a tail gate of the vehicle.

8. Motor vehicle as claimed in claim 1, wherein said at least one roof element comprises a rear roof element and forward roof elements which are located above the passenger compartment in the closed position and which are movable to the rear and which are lowerable with the rear roof element into the floor area.

9. Motor vehicle as claimed in claim 1, further comprising a cargo space separating window between an open cargo space produced in the open position and the passenger compartment.

10. Motor vehicle as claimed in claim 9, wherein the cargo space separating window lowerable to a position located behind seat backs of rear seats from raised separating position against the roof.

11. Motor vehicle as claimed in claim 10, wherein the cargo space separation is movably supported on the seat backs and can be folded down with the rear seat backs.

12. Motor vehicle as claimed in claim 11, wherein the rear seats are movable forward and back.

13. Motor vehicle as claimed in claim 5, further comprising a drive means which is controllable via an actuating means for moving the roof, side and rear elements and the D column parts for opening the rear structure from a closed or partially open position into the pickup truck configuration.

14. Motor vehicle as claimed in claim 1, wherein at least one of the elements is a transparent cover or a transparent pane.

15. Motor vehicle as claimed in claim 1, wherein the rear element is lowerable into a tail gate of the vehicle.
